(19) United States
(12) Patent Application Publication
(10) Pub. No.: US 2014/0073174 A1
(43) Pub. Date: Mar. 13, 2014

(54) ELECTRICAL CONNECTOR

(71) Applicant: FENNY YANG, NEW TAIPEI CITY 235 (TW)

(72) Inventor: FENNY YANG, NEW TAIPEI CITY 235 (TW)

(73) Assignee: ALL BEST ELECTRONICS CO., LTD.

(21) Appl. No.: 13/606,145

(22) Filed: Sep. 7, 2012

(51) Int. Cl. H01R 13/00

(52) U.S. Cl. 439/485

(57) ABSTRACT

An electrical connector for inserting onto a circuit board includes a case, and a plurality of ground units and transmission units alternately arranged in the case side by side. The transmission units respectively include a plurality of transmission members; and the ground units are capable of guiding heat energy produced by the electrical connector to the circuit board for dissipation. At least one coupling unit is coupled to the ground units and in contact with the circuit board, so that the heat energy can be more efficiently transferred from the ground units to the circuit board via the coupling unit to achieve upgraded heat dissipation effect. The ground units and the coupling unit also provide the function of preventing electromagnetic interference and crosstalk, so that the electrical connector can have increased signal transmission rate. With the above arrangements, the electrical connector has simplified structure and is easy to assemble.

### FIELD OF TECHNOLOGY

The present invention relates to an electrical connector, and more particularly to an electrical connector having alternately arranged ground units and transmission units as well as coupling units coupled to the ground units to enable enhanced heat dissipation effect.

### BACKGROUND

An electrical connector is used to achieve electrical connection between two electronic devices or two electronic interfaces, such as between two circuit boards or between an electronic device and a circuit board, so that data or signal can be transmitted therebetween.

A conventional electrical connector usually has a case, in which a plurality of transmission units and a plurality of ground units are arranged. Each of the transmission units includes a plurality of transmission members for signal transmission. The performance of the electrical connector is influenced by the length, shape and physical properties of the transmission members. Particularly, adjacent conductive terminals in an electrical connector for high-frequency and high-speed transmission tend to affect one another to produce, for example, crosstalk, electromagnetic interference (EMI) or transmission errors. Further, due to the inevitable trend of miniaturization of electrical connector, the length and shape of the conductive terminals as well as the arrangement of conducting path all form very important factors in the structural design of an electrical connector. In assembling the conventional electrical connector, the ground units and the transmission units are sequentially arranged side by side and the ground units are electrically connected to one another to form a ground circuit, so as to reduce the EMI produced by signal terminals during signal transmission.

However, with the arrangements in the conventional electrical connector, it is not able to avoid EMI or crosstalk between adjacent transmission members in the transmission units during signal transmission. In addition, with the ground units and the transmission units sequentially arranged side by side, conducting members must be used to electrically connect the ground units for forming the ground circuit. These conducting members result in complicated structure and troublesome assembling of the conventional electrical connector. Moreover, heat energy produced by the conventional electrical connector during operation thereof tends to accumulate in the electrical connector without being effectively dissipated therefrom and therefore adversely affects the transmission performance of the electrical connector.

### SUMMARY

A primary object of the present invention is to provide an electrical connector that has simplified structure and is easy to assemble, and has particular structural arrangements to enable enhanced EMI protection and accordingly increased signal transmission rate.

Another object of the present invention is to provide an electrical connector that has particular structural arrangement between ground units and a circuit board, so that heat energy produced by the electrical connector during operation thereof can be efficiently transferred via the ground units to the circuit board for dissipating into ambient air.

To achieve the above and other objects, the electrical connector according to a preferred embodiment of the present invention is configured for inserting onto a circuit board, and includes a case, a plurality of ground units arranged in the case, as well as a plurality of transmission units also arranged in the case. The transmission units respectively have a plurality of transmission members, and the ground units are capable of guiding heat energy produced by the electrical connector to the circuit board for dissipation.

According to an embodiment of the present invention, the electrical connector further includes at least one coupling unit coupled to the ground units and contacting with the circuit board for more efficiently transferring the heat energy produced by the electrical connector to the circuit board for dissipation; and the transmission units and the ground units are alternately arranged in the case, so that the transmission units are respectively located between two ground units.

According to an embodiment of the present invention, the ground units respectively include a first carrier plate and a conductive grounding member located in the first carrier plate and having a plurality of ground coupling heads; the transmission units respectively include a second carrier plate, in which the transmission members are located to space from one another; and the coupling unit is coupled to the ground coupling heads of the ground units.

According to an embodiment of the present invention, the first carrier plates respectively have a plurality of first notches, and the ground coupling heads are projected from the first carrier plates to locate in the first notches.

According to an embodiment of the present invention, the case is provided with a plurality of heat outlets, and the second carrier plates respectively have a plurality of second notches, and the heat outlets and the second notches are located at positions corresponding to the first notches on the first carrier plates.

According to an embodiment of the present invention, the at least one coupling unit includes a receiving section, a heat transfer section and a passageway. The receiving section provides a row of insertion slots, into which the ground coupling heads of the ground units are fitly inserted; the heat transfer section is in contact with the circuit board for transferring heat energy from the electrical connector to the circuit board; and the passageway extends a full length of the coupling unit.

According to an embodiment of the present invention, there are two transmission units located side by side between two ground units; the conductive grounding member of each ground unit has a plurality of ground terminals; the transmission members of each transmission unit provide a plurality of transmission terminals; and the transmission terminals on any two adjacent transmission units are offset from one another and offset from the ground terminals on the ground units.

According to an embodiment of the present invention, a heat conducting material is further provided between each coupling unit and a surface of the circuit board in contact with the coupling unit.

In brief, the electrical connector according to the present invention has simplified structure and is easy to assemble, and provides effective EMI protection to enable upgraded signal transmission rate. Moreover, via the ground units, heat energy produced by the electrical connector can be transferred to the circuit board and be quickly dissipated into ambient air from the circuit board; and the coupling units coupled to the ground units further enables enhanced heat dissipation effect, so that the electrical connector of the present invention has highly upgraded heat dissipation efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially exploded perspective view of an electrical connector according to a preferred embodiment of the present invention;

FIG. 2 is a schematic view of a ground unit for the electrical connector of FIG. 1;

FIG. 3 is a schematic view of a transmission unit for the electrical connector of FIG. 1;

FIG. 4 is a schematic view of another transmission unit for the electrical connector of FIG. 1;

FIG. 5 is a perspective view of a coupling unit for the electrical connector of FIG. 1;

FIG. 6 is an assembled perspective view of the electrical connector of FIG. 1 before being inserted onto a circuit board;

FIG. 7 is a side view showing the electrical connector of FIG. 6 having been inserted onto the circuit board;

FIG. 8 is a sectional view taken along line A-A of FIG. 7; and

FIG. 9 is an enlarged view of the circled area in FIG. 7.

### DETAILED DESCRIPTION

The present invention will now be described with a preferred embodiment thereof and with reference to the accompanying drawings.

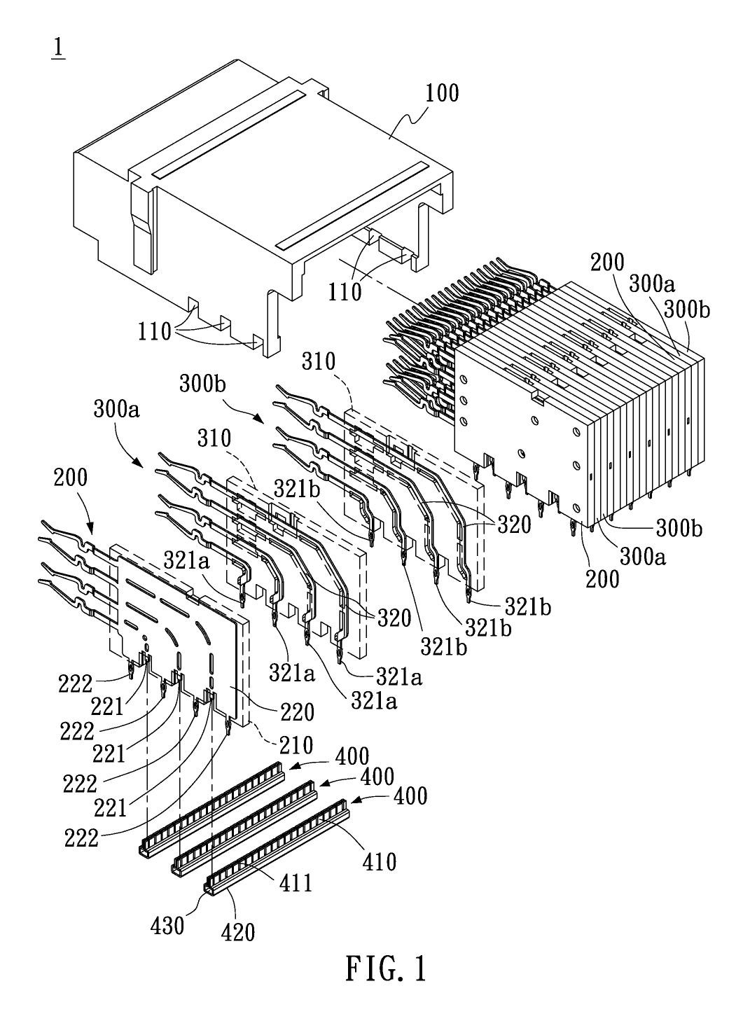

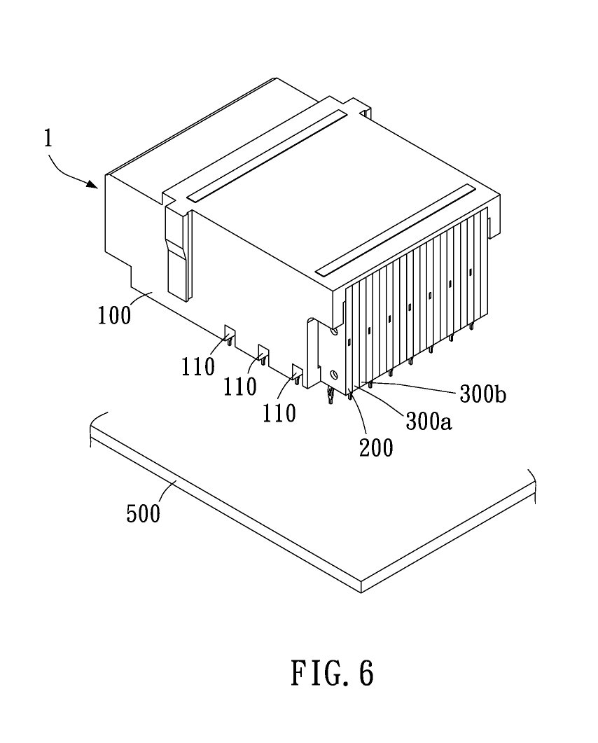

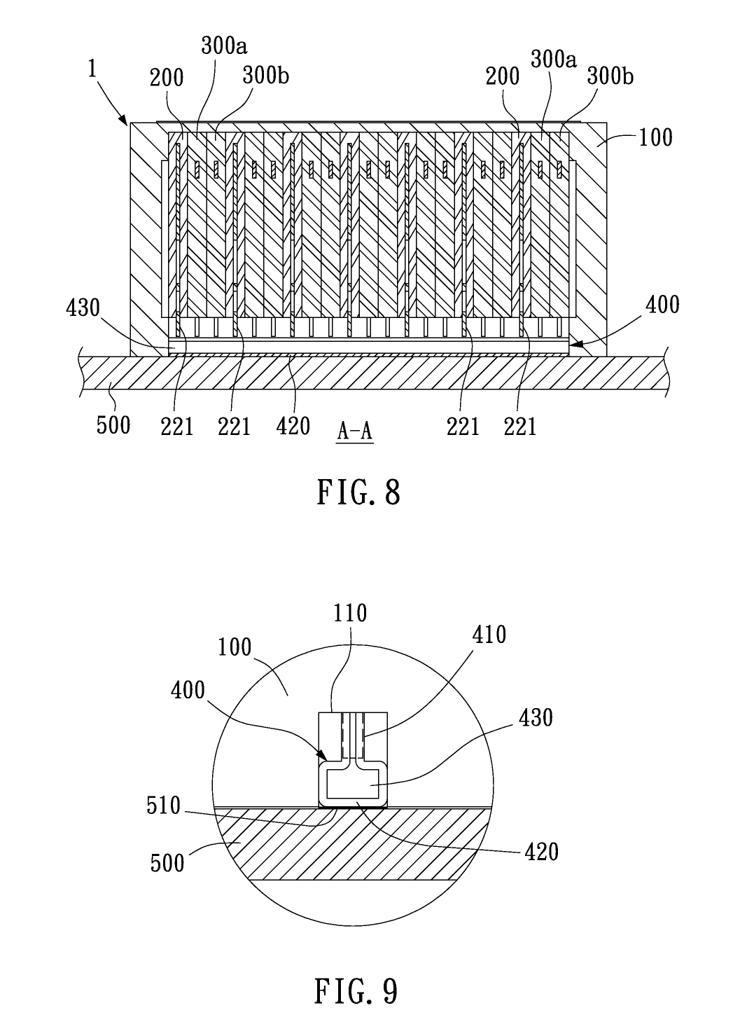

Please refer to FIG. 1 that is a partially exploded perspective view of an electrical connector 1 according to a preferred embodiment of the present invention. The electrical connector 1 is configured for inserting onto a circuit board 500 (see FIGS. 6-9), and mainly includes a case 100, a plurality of ground units 200, and a plurality of transmission units 300a, 300b. Heat energy produced by the electrical connector 1 during operation thereof can be transferred via the ground units 200 to the circuit board 500, from where the heat is dissipated into ambient air.

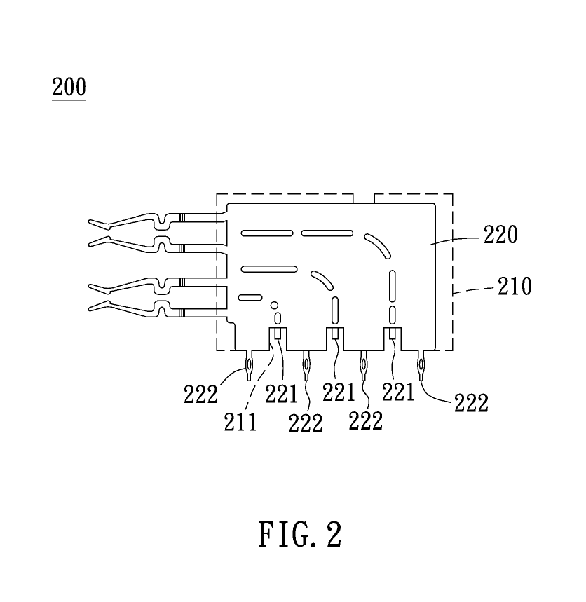

The ground units 200 are arranged in the case 100. As can be seen in FIG. 2, each of the ground units 200 includes a first carrier plate 210 and a conductive grounding member 220 located in the first carrier plate 210. The conductive grounding member 220 includes a plurality of ground coupling heads 221 and a plurality of ground terminals 222. The ground terminals 222 are projected from one side of the first carrier plate 210 for electrically connecting with the circuit board and other electronic elements or devices. When the electrical connector 1 is inserted onto the circuit board 500, the ground units 200 are in contact with the circuit board 500 and can therefore transfer heat energy in the electrical connector 1 to the circuit board 500, of which other surfaces and a reverse surface provide a large surface area for heat dissipation.

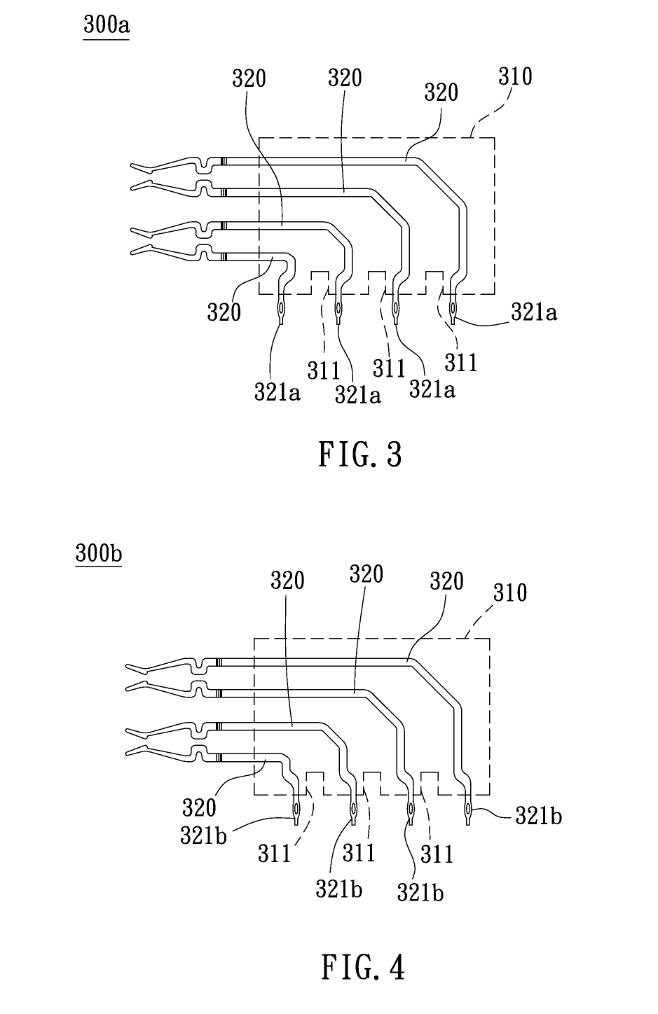

As can be seen in FIG. 1, the transmission units 300a, 300b are arranged in the case 100 to locate at one lateral side of each ground unit 200. As can be seen in FIGS. 3 and 4, each of the transmission units 300a, 300b includes a second carrier plate 310 and a plurality of spaced transmission members 320 located in the second carrier plate 310. The transmission members 320 respectively have a bent body, such that an end of each transmission member 320 is extended from one side of the second carrier plate 310 to project from another adjacent side thereof and form a transmission terminal 321a, 321b for electrically connecting with the circuit board and other electronic elements or devices.

As shown in FIG. 1, in the illustrated preferred embodiment, the ground units 200 and the transmission units 300a, 300b are arranged in the case 100 side by side to together constitute the electrical connector 1, into which an external transmission cable (not shown) can be plugged for data transmission. More specifically, there are two transmission units 300a, 300b arranged side by side between two ground units 200. FIG. 3 shows the transmission members 320 of each transmission unit 300a respectively have a transmission terminal 321a; and FIG. 4 shows the transmission members 320 of each transmission unit 300b respectively have a transmission terminal 321b. It is noted the transmission terminals 321a and the transmission terminals 321b of two adjoining transmission units 300a, 300b are offset from one another; and the ground terminals 222 of the ground units 200 are also offset from the transmission terminals 321a of the transmission units 300a and the transmission terminals 321b of the transmission units 300b. The transmission units 300a, 300b and the ground units 200 are arranged in compliance with the standards for relevant electrical connector specifications. It is also understood the present invention is not limited to the illustrated preferred embodiment but can be modified in design, so that the arrangement of the ground terminals and the transmission terminals can satisfy different electrical connector manufacturing specifications.

Please refer to FIGS. 1, 5 and 8. The electrical connector 1 of the present invention further includes at least one coupling unit 400. In the illustrated preferred embodiment, three coupling units 400 are shown. The coupling units 400 are coupled to the ground units 200 for more efficiently transferring heat energy produced by the electrical connector 1 during operation thereof to the circuit board 500 for dissipation; and the transmission units 300a, 300b and the ground units 200 are alternately arranged in the case 100, so that the transmission units 300a, 300b are respectively located between two ground units 200. More specifically, the coupling units 400 are coupled to the ground coupling heads 221, so as to electrically connect with the conductive grounding members 220 of the ground units 200. And, the electrical connection of the coupling units 400 with the conductive grounding members 220 of the ground units 200 provides the function of preventing electromagnetic interference (EMI) and crosstalk between the transmission units 300a, 300b in the electrical connector 1.

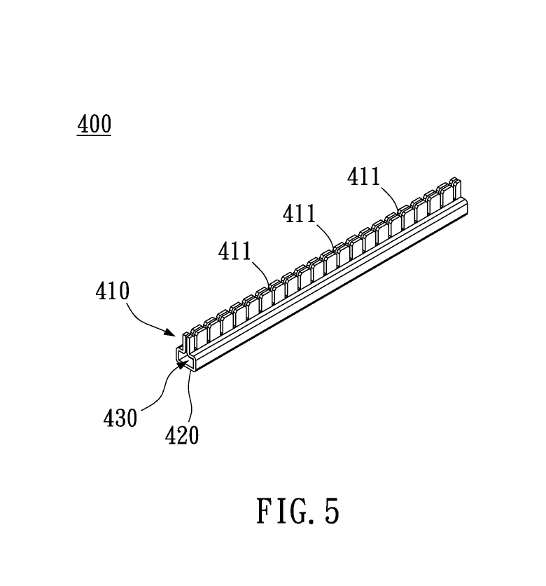

In the illustrated preferred embodiment, as shown in FIG. 2, the first carrier plate 210 of each ground unit 200 is provided with a plurality of first notches 211, and the ground coupling heads 221 of the conductive grounding members 220 are projected from the first carrier plate 210 to locate in the first notches 211. On the other hand, as shown in FIGS. 4 and 5, the second carrier plates 310 of the transmission units 300a, 300b respectively have a plurality of second notches 311 located at positions corresponding to those of the first notches 211 for receiving the coupling units 400 therein.

In the preferred embodiment of the present invention shown in FIG. 1, each first carrier plate 210 has three first notches 211, and each second carrier plate 310 has three second notches 311 located corresponding to the three first notches 211. Therefore, when the ground units 200 and the transmission units 300a, 300b are alternately arranged in the case 100 side by side, the first notches 211 on the first carrier plates 210 are aligned with the corresponding second notches 311 on the second carrier plates 310 to together form three transverse recesses for receiving the three coupling units 400 therein. Via the coupling units 400 received in the above-mentioned three transverse recesses, the conductive grounding members 220 are electrically connected to one another.

In the illustrated preferred embodiment, as shown in FIGS. 1, 6 and 7, the case 100 further includes a plurality of heat outlets 110 symmetrically formed on two lateral sides of the case 100. The heat outlets 110 on the case 100 are located corresponding to the first notches 211 and the second notches 311. When the electrical connector 1 is connected to an external transmission cable (not shown), a part of the heat energy produced by the transmission members 320 of the transmission units 300a, 300b during signal transmission is transferred via the ground units 200 and/or the coupling units 400 to the circuit board 500 without accumulating in the electrical connector 1, and other part of the produced heat energy is directly dissipated into a space outside the electrical connector 1 via the heat outlets 110 on the case 100. Therefore, the electrical connector 1 has enhanced heat dissipation effect. According to the present invention, the heat outlets 110 may be in the form of notches or openings without being particularly limited to the shape illustrated in the drawings.

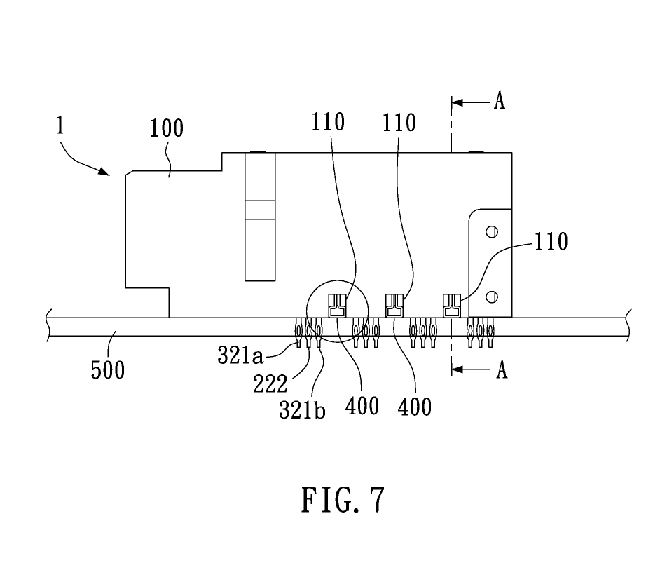

Please refer to FIGS. 5 and 9 at the same time. Each of the coupling units 400 includes a receiving section 410, a heat transfer section 420, and a passageway 430. The receiving section 410 provides a row of insertion slots 411, into which the ground coupling heads 221 of the ground units 200 are fitly inserted. The heat transfer section 420 serves to transfer heat from the electrical connector 1 to the circuit board 500. The passageway 430 extends a full length of the coupling unit 400. As can be seen in FIGS. 7 and 9, the passageways 430 are communicable with the heat outlets 110. In the preferred embodiment, as shown in FIGS. 5 and 9, each coupling unit 400 is manufactured by bending a metal sheet with good heat conductivity, so as to form a generally rectangular-sectioned passageway 430, which has an upward extended upper side forming the receiving section 410 and a flat lower side forming the heat transfer section 420.

Further, as shown in FIGS. 6 to 9, in the illustrated electrical connector 1, the coupling units 400 are pressed against a surface of the circuit board 500, so that the heat energy produced by the transmission units 300a, 300b is transferred via the coupling units 400 to the circuit board 500 to ensure enhanced heat dissipation of the electrical connector 1. Moreover, the coupling units 400 may be respectively received in one transverse recess formed by the aligned first and second notches 211, 311 with two opposite ends thereof exposed from the heat outlets 110 on the case 100 to further upgrade the heat dissipation effect of the electrical connector 1.

The passageway 430 of each coupling unit 400 extends a full length of the coupling unit 400 and has two open ends communicating with two corresponding heat outlets 110 provided on the case 100, so as to form an air path. The heat energy transferred from the transmission units 300a, 300b to the coupling units 400 can be carried by the air in the passageways 430 to an outer side of the case 100 to upgrade the heat dissipation effect of the electrical connector 1.

The circuit board 500 is provided on its surface with copper-coated areas, which enable upgraded heat transfer effect. The heat transfer sections 420 of the coupling units 400 are in contact with the copper-coated areas on the circuit board 500, so as to ensure even better heat transfer effect between the electrical connector 1 and the circuit board 500. A heat conducting material 510, such as a thermal paste, can be further provided between the heat transfer sections 420 of the coupling units 400 and the copper-coated areas of the circuit board 500 to obtain further increased heat transfer effect.

With the above arrangements, it is able to reduce the signal interference or crosstalk between the transmission units 300a, 300b of the electrical connector 1 according to the present invention. That is, the electrical connector 1 of the present invention can have improved signal transmission performance. Further, by coupling the ground units 200 to the coupling units 400, the electrical connector 1 of the present invention can have largely upgraded heat dissipation efficiency.

The above-described electrical connector structure according to the present invention can be applied to a large number of electrical connectors for use with existing transmission cables of different specifications. In most cases, the only differences between the electrical connectors for use with transmission cables of different specifications are their overall size and the arrangement of the transmission units 300a, 300b. More specifically, the electrical connectors used with transmission cables of different specifications have transmission members different in length and shape, as well as have first and second carrier plates and cases different in shape and size. Nevertheless, all these electrical connectors having different specifications can employ the structure provided by the present invention and utilize the ground units and the coupling units to achieve the effect of EMI protection. Therefore, the scope of the present invention covers all kinds of electrical connectors that employ the above-described arrangements.

In brief, the electrical connector according to the present invention has simplified structure and is easy to assemble, and provides effective EMI protection to enable upgraded signal transmission rate. Moreover, via the ground units, heat energy produced by the electrical connector can be transferred to the circuit board and be quickly dissipated into ambient air from the circuit board; and the coupling units coupled to the ground units further enables enhanced heat dissipation effect, so that the electrical connector of the present invention has highly upgraded heat dissipation efficiency.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An electrical connector for inserting onto a circuit board, comprising:
a case;
a plurality of ground units being arranged in the case; and
a plurality of transmission units being arranged in the case and respectively including a plurality of transmission members;
wherein the ground units are capable of guiding heat energy produced by the electrical connector during operating thereof to the circuit board, from where the heat energy is dissipated into ambient air.

2. The electrical connector as claimed in claim 1, further comprising at least one coupling unit coupled to the ground units for transferring the heat energy produced by the electrical connector from the ground units to the circuit board for dissipation; and wherein the transmission units and the ground units are alternately arranged in the case, so that the transmission units are respectively located between two ground units.

3. The electrical connector as claimed in claim 2, wherein the ground units respectively include a first carrier plate and a conductive grounding member located in the first carrier plate and having a plurality of ground coupling heads; and wherein the transmission units respectively include a second carrier plate, in which the transmission members are located to space from one another; and the coupling unit being coupled to the ground coupling heads of the ground units.

4. The electrical connector as claimed in claim 3, wherein the first carrier plates respectively have a plurality of first notches, and the ground coupling heads being projected from the first carrier plates to locate in the first notches.

5. The electrical connector as claimed in claim 4, wherein the case is provided with a plurality of heat outlets, and the second carrier plates respectively have a plurality of second notches; and the heat outlets and the second notches being located at positions corresponding to the first notches.

6. The electrical connector as claimed in claim 5, wherein the at least one coupling unit includes a receiving section, a heat transfer section and a passageway; the receiving section providing a row of insertion slots, into which the ground coupling heads of the ground units are fitly inserted; the heat transfer section being in contact with the circuit board for transferring heat energy from the electrical connector to the circuit board; and the passageway extending a full length of the coupling unit.

7. The electrical connector as claimed in claim 3, wherein there are two transmission units located side by side between two ground units, the conductive grounding member of each ground unit has a plurality of ground terminals, and the transmission members of each transmission unit provide a plurality of transmission terminals; and the transmission terminals on any two adjacent transmission units are offset from one another and offset from the ground terminals on the ground units.

8. The electrical connector as claimed in claim 3, further comprising a heat conducting material being provided between each coupling unit and a surface of the circuit board in contact with the coupling unit.
